(19) United States
(12) Patent Application Publication
(10) Pub. No.: US 2016/0080629 A1
(43) Pub. Date: Mar. 17, 2016

(54) CAMERA SYSTEM AND ELECTRONIC DEVICE

(71) Applicant: Kabushiki Kaisha Toshiba, Minato-ku (JP)

(72) Inventor: Takashi HOSOE, Kawasaki (JP)

(73) Assignee: Kabushiki Kaisha Toshiba, Minato-ku (JP)

(21) Appl. No.: 14/844,122

(22) Filed: Sep. 3, 2015

(30) Foreign Application Priority Data
Sep. 16, 2014 (JP) 2014-188154

(51) Int. Cl. H04N 5/232; H04N 5/235

(52) U.S. Cl. CPC H04N 5/23206; H04N 5/235

(57) ABSTRACT

According to one embodiment, a camera system comprises a camera module and a first processing unit. The first processing unit comprises a first controller and a second controller. The first controller can receive commands from a second processing unit. The first controller executes a command destined for the first processing unit from among the received commands. The second controller transmits a command destined for the camera module from among the received commands to the camera module.

### CROSS-REFERENCE TO RELATED APPLICATIONS

This application is based upon and claims the benefit of priority from Japanese Patent Application No. 2014-188154, filed on Sep. 16, 2014; the entire contents of which are incorporated herein by reference.

### FIELD

Embodiments described herein relate generally to a camera system and an electronic device.

### BACKGROUND

In electronic devices which comprise a camera system and a host, the host controls the camera system. With the camera system comprising a camera module and a signal processing unit, the host may transmit commands to both the camera module and the signal processing unit. The host is the master in control of this data communication. The camera module and signal processing unit are slaves operating under the control of the host. Since a plurality of slaves exist for the master, the control of the camera system in the electronic device may be complicated.

### BRIEF DESCRIPTION OF THE DRAWINGS

FIG. 1 is a block diagram showing schematically the configuration of an electronic device comprising a camera system of a first embodiment; and

FIG. 2 is a block diagram showing schematically the configuration of an electronic device comprising a camera system of a second embodiment.

### DETAILED DESCRIPTION

According to one embodiment, a camera system comprises a camera module and a first processing unit. The camera module captures an object image. The camera module generates an image signal corresponding to the object image. The first processing unit processes the image signal from the camera module. The first processing unit can connect to a second processing unit. The second processing unit controls the camera system. The first processing unit comprises a first controller and a second controller. The first controller can receive commands from the second processing unit. The first controller executes a command destined for the first processing unit from among the received commands. The second controller transmits a command destined for the camera module from among the received commands to the camera module.

The camera systems and electronic devices according to embodiments will be described in detail below with reference to the accompanying drawings. The present invention is not limited to these embodiments.

### First Embodiment

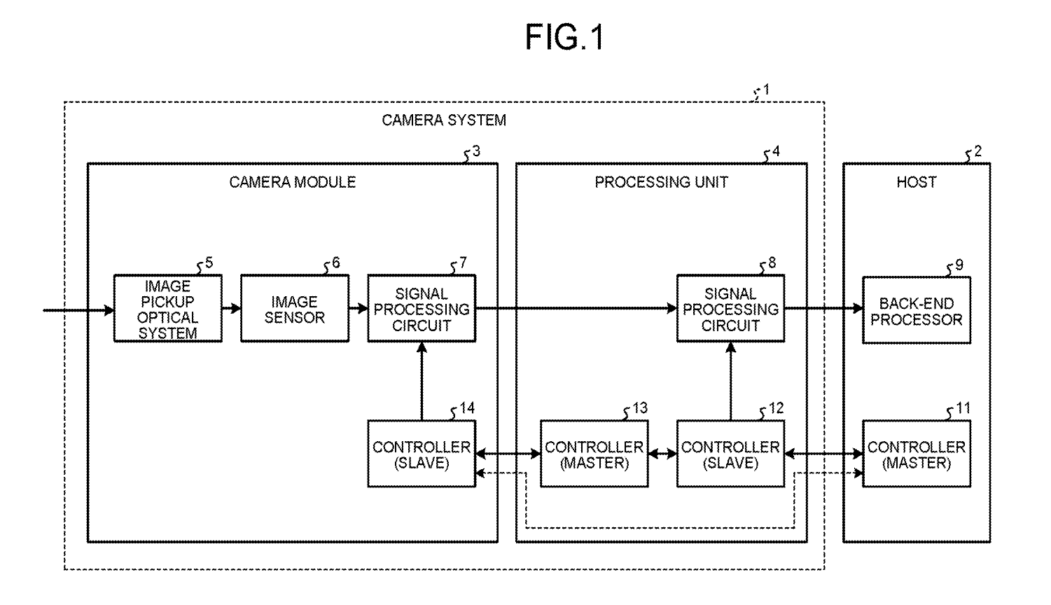

FIG. 1 is a block diagram showing schematically the configuration of an electronic device comprising a camera system of the first embodiment. The electronic device comprises a camera system 1 and a host 2. The electronic device is a mobile terminal with a camera. The electronic device may be one other than a mobile terminal with a camera, such as a digital still camera or a digital video camera.

The camera system 1 comprises a camera module 3 and a processing unit 4. The camera module 3 comprises an image pickup optical system 5, an image sensor 6, a signal processing circuit 7, and a controller 14. The constituents of the camera module 3 are implemented on one chip.

The image pickup optical system 5 takes in light from an object to form an object image. The image sensor 6 captures the object image. The image sensor 6 generates an image signal corresponding to the object image. The image sensor 6 is, for example, a CMOS image sensor.

The signal processing circuit 7 that is a first signal processing circuit performs a variety of signal processing on the image signal from the image sensor 6. The signal processing circuit 7 includes a circuit that performs black level adjustment for the image signal, and the like as respective circuits for functions. The black level is a signal level as a reference when luminance levels are expressed as gray levels and is a signal level indicating the lowest gray level. The camera module 3 performs feedback control of the image sensor 6 based on data having undergone signal processing in the signal processing circuit 7.

The controller 14 is a fourth controller of the electronic device and a camera controller of the camera system 1. The controller 14 executes commands from a controller 13 described later, thereby controlling the signal processing circuit 7. The camera module 3 outputs the image signal having undergone processing in the signal processing circuit 7 to the processing unit 4.

The processing unit 4 that is a first processing unit is a companion chip that performs processing to realize camera functions. The processing unit 4 comprises a signal processing circuit 8 and controllers 12, 13.

The signal processing circuit 8 that is a second signal processing circuit performs a variety of signal processing on the image signal from the camera module 3. The signal processing circuit 8 includes respective circuits for noise removal, high dynamic range (HDR) composition, shading correction, distortion correction, and the like as respective circuits for functions.

The controller 12 is a first controller of the electronic device and the camera system 1. The controller 12 executes commands from a controller 11 described later, thereby controlling the signal processing circuit 8.

The controller 13 is a second controller of the electronic device and the camera system 1. The controller 13 sends commands received from the controller 12 to the controller 14.

The constituents of the processing unit 4 are implemented on one chip. Each constituent of the processing unit 4 is constituted by an integrated circuit. The camera system 1 outputs the image signal having undergone processing in the signal processing circuit 8 to the host 2. The camera module 3 and the processing unit 4 may be formed on a common substrate.

The host 2 that is a second processing unit comprises a back-end processor 9 and the controller 11. The back-end processor 9 performs a variety of signal processing on the image signal from the camera system 1. The back-end processor 9 performs pixel interpolation (demoniac), white balance adjustment, resolution restoration, and the like as signal processing.

The host 2 stores the image signal having undergone signal processing in the back-end processor 9 in a storage unit (not shown). The host 2 outputs the image signal in the storage unit to a display unit (not shown) according to operation or the like by a user. The display unit displays an image according to the image signal inputted from the back-end processor 9 or the storage unit.

The controller 11 is a third controller of the electronic device and the host 2 connected to the camera system 1. The controller 11 transmits commands destined for the processing unit 4 and commands destined for the camera module 3 to the processing unit 4.

The signal processing circuit 8 has a larger-scale circuit configuration than the signal processing circuit 7. The signal processing circuit 8 performs signal processing that requires a larger scale circuit than the signal processing performed in the signal processing circuit 7. The signal processing circuit 8 can perform relatively advanced signal processing as compared with the signal processing performed in the signal processing circuit 7.

The back-end processor 9 performs general image processing on raw data. The back-end processor 9 has a general-purpose circuit configuration. In contrast, the signal processing circuit 8 has a dedicated circuit configuration for the camera system 1 of the embodiment. The signal processing circuit 8 can perform signal processing suitable for the functions of the camera system 1 of the first embodiment.

Note that a variety of signal processing illustrated in the embodiment may be performed in any of the signal processing circuits 7, 8 and the back-end processor 9. The signal processing circuits 7, 8 and the back-end processor 9 may perform other signal processing than the signal processing illustrated in the embodiment.

The controllers 11 and 12 are connected via an interface such as I2C. The controller 11 is the master in data communication between the controllers 11 and 12.

The controller 12 is a slave operating under the control of the controller 11. An individual slave address is assigned to the controller 12. The controllers 11 and 12 may perform data communication other than I2C communication such as SPI communication.

The controllers 13 and 14 are connected via an interface such as I2C. The controller 13 transmits commands received from the controller 12 to the controller 14. The controller 13 is the master in data communication between the controllers 13 and 14.

The controller 14 is a slave operating under the control of the controller 13. The controllers 13 and 14 may perform data communication other than I2C communication such as SPI communication.

The electronic device accepts operation for the camera system 1 by a user. When the electronic device is instructed to change the state or setting of the camera system 1 through operation or the like by a user, the controller 11 of the host 2 produces a command according to the meaning of the instruction. Commands destined for the camera system 1 include the slave address of the controller 12.

Registers (not shown) are provided inside each of the signal processing circuits 8 and 7. The registers store register values that are data denoting the respective states or settings of functions. The respective states of the functions are respective ON/OFF states of the functions. Commands include a data address specifying either a data storage location in the signal processing circuit 8 or a data storage location in the signal processing circuit 7.

The controller 11 transmits the produced command to the controller 12. In the case of I2C communication, when receiving a command from the controller 11, the controller 12 transmits an acknowledgement (ACK) to the controller 11. In the case of other data communication than I2C communication, the controller 12 may not return an ACK to the controller 11.

The controller 12 determines whether the data address included in the command received from the controller 11 specifies a storage location in the signal processing circuit 8 or in the signal processing circuit 7. If the received command includes a data address specifying a storage location in the signal processing circuit 8, the controller 12 executes that command. The controller 12 controls the signal processing circuit 8 according to that command.

The controller 12 sets a register value in the register specified by the data address according to that command. In this way, the processing unit 4 executes a command destined for the processing unit 4 from among commands received by the processing unit 4. The signal processing circuit 8 performs signal processing according to the register value.

In contrast, if the received command includes a data address specifying a storage location in the signal processing circuit 7, the controller 12 passes that command to the controller 13. The controller 13 transmits the command passed from the controller 12 to the controller 14. The controller 13 transmits a command destined for the camera module 3 from among commands received by the processing unit 4 to the camera module 3. The processing unit 4 transmits the command to the camera module 3 without storing data into a register in the signal processing circuit 8.

In the case of I2C communication, when receiving a command from the controller 13, the controller 14 transmits an acknowledgement (ACK) to the controller 13. The controller 13 passes the ACK from the controller 14 to the controller 12.

The controller 12 transmits the ACK passed from the controller 13 to the controller 11. In the case of other data communication than I2C communication, the controller 14 may not return an ACK to the controller 11.

The controller 14 receives the command including a data address specifying a storage location in the signal processing circuit 7. The controller 14 executes that command. The controller 14 controls the signal processing circuit 7 according to that command.

The controller 14 sets a register value in the register specified by the data address according to that command. In this way, the camera module 3 executes a command destined for the camera module 3. The signal processing circuit 7 performs signal processing according to data stored in the register.

The range of the data storage area in the camera system 1 that the host 2 can access is referred to as the address space of the camera system 1. Let the range of 0x0000 to 0x1100 in the address space of the camera system 1 be the data storage area of the camera module 3. The data storage area of the camera module 3 includes the storage locations in the signal processing circuit 7. Let the range of 0x1000 to 0x2000 be the data storage area of the processing unit 4. The data storage area of the processing unit 4 includes the storage locations in the signal processing circuit 8.

The range of 0x1000 to 0x1100 is both part of the data storage area of the camera module 3 and part of the data storage area of the processing unit 4. The part of the data storage area of the camera module 3 and the part of the data storage area of the processing unit 4 are specified by addresses of the same range of numerical values. The address space includes the overlap range between the range of the data storage area of the camera module 3 and the range of the data storage area of the processing unit 4.

Assume that the controller 12 has received a command specifying a data address in the range of 0x0000 to 0x0FFF. The controller 12 determines that the command is destined for the camera module 3. The controller 12 passes that command to the controller 13.

The host 2 produces a command specifying a data address in the range of 0x0000 to 0x0FFF when an instruction for an exclusive setting in the camera module 3 is given. Exclusive settings in the camera module 3 include settings concerning the quality of images captured by the camera module 3 such as settings concerning black level adjustment.

Assume that the controller 12 has received a command specifying a data address in the range of 0x1000 to 0x1100. The controller 12 determines that the command is a common command destined for both the camera module 3 and the processing unit 4. The controller 12 passes that command to the controller 13 and also executes that command.

The host 2 produces a command specifying a data address in the range of 0x1000 to 0x1100 when an instruction for both the camera module 3 and the processing unit 4 is given. For example, for an instruction to turn on/off the operation of the camera module 3 and the processing unit 4, the host 2 produces a command specifying such a data address.

When receiving a common instruction for both the camera module 3 and the processing unit 4, the host 2 produces a command specifying an address in such an overlap range. The host 2 can change settings or states of the camera module 3 and the processing unit 4 by sending a command specifying one address to the processing unit 4. The host 2 can easily control the camera system 1 as compared with the case of transmitting individually-produced commands to the camera module 3 and the processing unit 4 respectively.

Assume that the controller 12 has received a command specifying a data address in the range of 0x1101 to 0x2000. The controller 12 determines that the command is destined for the processing unit 4. The controller 12 executes that command.

The host 2 produces a command specifying a data address in the range of 0x1101 to 0x2000 when an instruction for an exclusive setting in the processing unit 4 is given. Such instructions include instructions to switch on/off a variety of signal processing performed by the processing unit 4 and instructions to change settings for the signal processes respectively.

Note that the embodiment is not limited to the case where the data storage area of the camera module 3 and the data storage area of the processing unit 4 have a common range which can be specified by addresses of the same range of numerical values. The address space does not have to have an overlap range between the range of the data storage area of the camera module 3 and the range of the data storage area of the processing unit 4.

The controller 11 may be able to switch between transmitting a command destined for the camera module 3 to the controller 12 and transmitting it to the controller 14. A broken-line double arrow in FIG. 1 indicates the path of data communication between the controllers 11 and 14.

In such data communication, the controller 14 is a slave for the controller 11 that is the master. An individual slave address is assigned to the controller 14. Commands to be transmitted from the controller 11 to the controller 14 are made to include the slave address of the controller 14. In this case, two slaves exist for the controller 11 that is the master.

The electronic device can switch between data communication in which two slaves exist for the controller 11 that is the master and data communication in which one slave exists. Thus, the effect of making the control of the camera system 1 easy can be obtained.

According to the embodiment, in the camera system 1, the processing unit 4 is provided with the controllers 12 and 13. The controller 11 of the host 2 transmits commands to the controller 12. In this data communication, the controller 11 is the master. The controller 12 is a slave. In the electronic device, as to the control of the camera system 1, data communication from the master to one slave is possible. As compared with the case where a plurality of slaves exist for a master, the electronic device can easily control the camera system 1.

The electronic device can easily control the camera system 1 as compared with the case where the host 2 serially transmits commands to both the camera module 3 and the processing unit 4. Further, the electronic device can easily perform synchronous control of the camera module 3 and the processing unit 4. As above, the effect of enabling the easy control of the camera system 1 is produced.

### Second Embodiment

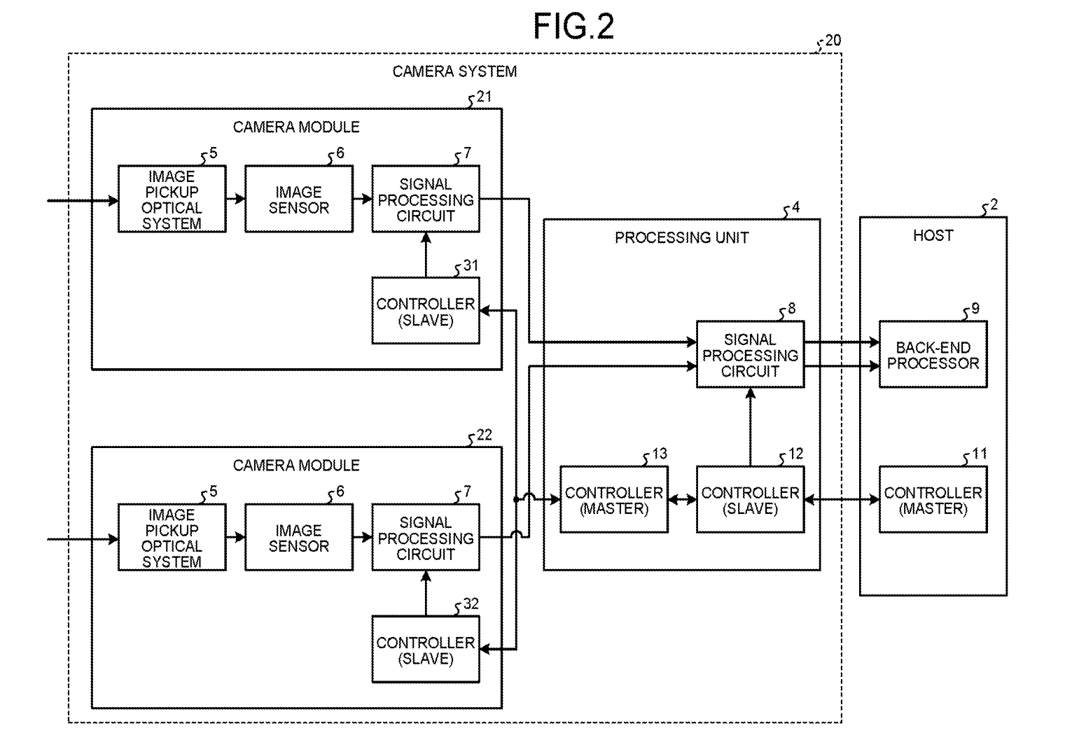

FIG. 2 is a block diagram showing schematically the configuration of an electronic device comprising a camera system of the second embodiment. The same reference numerals are used to denote the same parts as in the first embodiment, and duplicate description thereof is omitted as needed. The electronic device comprises a camera system 20 and the host 2. The camera system 20 comprises camera modules 21, 22 and the processing unit 4.

The camera module 21, a first camera module, comprises an image pickup optical system 5, an image sensor 6, a signal processing circuit 7, and a controller 31. The controller 31 executes commands from the controller 13, thereby controlling the signal processing circuit 7. The constituents of the camera module 21 are implemented on one chip.

The camera module 22, a second camera module, comprises an image pickup optical system 5, an image sensor 6, a signal processing circuit 7, and a controller 32. The controller 32 executes commands from the controller 13, thereby controlling the signal processing circuit 7. The constituents of the camera module 22 are implemented on one chip.

The controllers 31, 32 are a fourth controller of the electronic device and camera controllers of the camera system 20. The camera modules 21 and 22 have the same configuration. The processing unit 4 processes an image signal from the camera module 21 and an image signal from the camera module 22.

A signal processing circuit 8 performs a variety of signal processing on image signals from the camera modules 21, 22. The signal processing circuit 8 performs the same signal processing as the signal processing circuit 8 of the first embodiment. In addition, the signal processing circuit 8 of the second embodiment performs signal processing for obtaining a stereoscopic vision (3D) image.

The signal processing circuit 8 may perform any signal process using image signals from the two camera modules 21 and 22. The signal processing circuit 8 can perform signal processing suitable for the functions of the camera system 20 of the second embodiment.

The controller 12, a first controller, executes commands from the controller 11, thereby controlling the signal processing circuit 8. The controller 13, a second controller, sends commands received from the controller 12 to the controllers 31, 32.

The controller 11, a third controller, transmits commands destined for the processing unit 4, commands destined for the camera module 21, and commands destined for the camera module 22 to the processing unit 4.

The controllers 13 and 31 are connected via an interface such as I2C. The controllers 13 and 32 are connected via an interface such as I2C. The controller 13 transmits commands received from the controller 12 to the controllers 31 and 32.

The controller 13 is the master in data communication between the controller 13 and the controllers 31, 32. The controllers 31 and 32 are slaves operating under the control of the controller 13. The controller 13 and the controllers 31, 32 may perform data communication other than I2C communication such as SPI communication.

The controller 12 determines whether the data address included in each command received from the controller 11 specifies a storage location in the signal processing circuit 8 of the processing unit 4 or in the signal processing circuit 7 of the camera module 21, 22.

If the received command includes a data address specifying a storage location in the signal processing circuit 7 of the camera module 21, 22, then the controller 12 passes that command to the controller 13. The controller 13 transmits the command passed from the controller 12 to the controller 31, 32.

The controller 13 transmits a command destined for the camera module 21 from among commands received by the processing unit 4 to the camera module 21. The controller 13 transmits a command destined for the camera module 22 from among commands received by the processing unit 4 to the camera module 22.

The controller 31 receives the command including a data address specifying a storage location in the signal processing circuit 7 of the camera module 21. The controller 31 executes that command. The controller 31 controls the signal processing circuit 7 according to that command.

The controller 32 receives the command including a data address specifying a storage location in the signal processing circuit 7 of the camera module 22. The controller 32 executes that command. The controller 32 controls the signal processing circuit 7 according to that command.

In the case of I2C communication, when receiving a command from the controller 13, the controller 31, 32 transmits an acknowledgement (ACK) to the controller 13. The controller 13 passes the ACK from the controller 31, 32 to the controller 12.

The controller 12 transmits the ACK passed from the controller 13 to the controller 11. Note that, in the case of other data communication than I2C communication, the controller 31, 32 may not return an ACK to the controller 11.

The data storage area of the camera module 21 and the data storage area of the camera module 22 are specified by addresses of the same range of numerical values. In the address space of the camera system 1, the range of the data storage area of the camera module 21 and the range of the data storage area of the camera module 22 overlap each other.

The host 2 produces a command specifying a data address common to the camera modules 21 and 22 when an instruction for settings of both the camera modules 21 and 22 is given. Settings of both the camera modules 21 and 22 include settings concerning the quality of images captured by the camera modules 21, 22 such as settings concerning black level adjustment.

When receiving an instruction for the camera modules 21, 22, the host 2 specifies an address common to the two. The controller 11 transmits a command including the common data address as commands for the camera modules 21 and 22 to the controller 12.

The host 2 can change the settings or states of both the camera modules 21 and 22 by specifying one address. As compared with the case where individual addresses need to be specified for the two, the host 2 can easily control the camera system 20.

The electronic device can easily control the camera system 20 as compared with the case where the host 2 serially transmits commands to both the camera modules 21 and 22. Further, the electronic device can easily perform synchronous control of the camera modules 21 and 22. Also with the second embodiment, the effect of enabling the easy control of the camera system 20 is produced as with the first embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A camera system comprising:
a camera module configured to capture an object image and generate an image signal corresponding to the object image; and
a first processing unit configured to process the image signal from the camera module, the first processing unit configured to be able to connect to a second processing unit, the second processing unit controlling the camera system, wherein
the first processing unit comprises:
a first controller configured to be able to receive commands from the second processing unit and execute a command destined for the first processing unit from among the received commands; and
a second controller configured to transmit a command destined for the camera module from among the received commands to the camera module.

2. The camera system according to claim 1, wherein the camera module comprises a camera controller configured to execute a command received from the second controller.

3. The camera system according to claim 2, wherein
the camera module comprises a first signal processing circuit configured to process the generated image signal, the camera controller executing the received command to control the first signal processing circuit, and
the first processing unit comprises a second signal processing circuit configured to process the image signal from the camera module, the first controller executing the received command to control the second signal processing circuit.

4. The camera system according to claim 3, wherein
in a case where a command received by the first controller includes an address specifying a data storage location in the second signal processing circuit, the first controller executes the received command, and
in a case where the command received by the first controller includes an address specifying a data storage location in the first signal processing circuit, the second controller transmits the received command passed from the first controller to the camera controller.

5. The camera system according to claim 3, wherein the circuit scale of the second signal processing circuit is larger than that of the first signal processing circuit.

6. The camera system according to claim 1, wherein
the data storage area of the camera system which the second processing unit can access includes the data storage area of the first processing unit and the data storage area of the camera module, and
part of the data storage area of the first processing unit and part of the data storage area of the camera module are specified by addresses of a same range of numerical values.

7. The camera system according to claim 6, wherein
in a case where receiving a command including an address in an overlap range between the data storage area of the first processing unit and the data storage area of the camera module, the first controller passes the received command to the second controller and also executes the received command, and
the second controller transmits the received command passed from the first controller to the camera controller.

8. The camera system according to claim 1, comprising a first camera module and a second camera module, the first processing unit processing an image signal from the first camera module and an image signal from the second camera module, wherein
the second controller transmits a command destined for the first camera module from among the received commands to the first camera module and a command destined for the second camera module to the second camera module.

9. The camera system according to claim 8, wherein
the data storage area of the camera system which the second processing unit can access includes the data storage area of the first camera module and the data storage area of the second camera module, and
the data storage area of the first camera module and the data storage area of the second camera module are specified by addresses of a same range of numerical values.

10. An electronic device including:
a camera system which comprises a camera module and a first processing unit, the camera module configured to capture an object image and generate an image signal corresponding to the object image, the first processing unit configured to process the image signal from the camera module; and
a second processing unit configured to control the camera system, the second processing unit being connected to the first processing unit, wherein
the first processing unit comprises:
a first controller configured to receive commands from the second processing unit and execute a command destined for the first processing unit from among the received commands; and
a second controller configured to transmit a command destined for the camera module from among the received commands to the camera module, and
the second processing unit comprises a third controller configured to transmit a command destined for the first processing unit and a command destined for the camera module to the first processing unit.

11. The electronic device according to claim 10, wherein the camera module comprises a fourth controller configured to execute a command received from the second controller.

12. The electronic device according to claim 11, wherein
the camera module comprises a first signal processing circuit configured to process the generated image signal, the fourth controller executing the command to control the first signal processing circuit, and
the first processing unit comprises a second signal processing circuit configured to process the image signal from the camera module, the first controller executing the command to control the second signal processing circuit.

13. The electronic device according to claim 12, wherein the third controller transmits the commands including an address specifying a data storage location in the first signal processing circuit or an address specifying a data storage location in the second signal processing circuit to the first controller.

14. The electronic device according to claim 13, wherein
when a command including an address specifying a data storage location in the second signal processing circuit is transmitted from the third controller, the first controller executes the command from the third controller, and
when a command including an address specifying a data storage location in the first signal processing circuit is transmitted from the third controller, the second controller transmits the command from the third controller to the fourth controller.

15. The electronic device according to claim 10, wherein the third controller transmits a command including a slave address assigned to the first controller to the first controller.

16. The electronic device according to claim 10, wherein
the second processing unit accesses the data storage area of the camera system, the data storage area of the camera system including the data storage area of the first processing unit and the data storage area of the camera module, and
part of the data storage area of the first processing unit and part of the data storage area of the camera module are specified by addresses of a same range of numerical values.

17. The electronic device according to claim 16, wherein the third controller transmits a command including an address in an overlap range between the data storage area of the first processing unit and the data storage area of the camera module, as a common command for both the first processing unit and the camera module, to the first controller.

18. The electronic device according to claim 10, wherein
the camera system comprises a first camera module and a second camera module being camera modules, the first processing unit processing an image signal from the first camera module and an image signal from the second camera module, and
the third controller transmits a command destined for the first camera module and a command destined for the second camera module to the first processing unit.

19. The electronic device according to claim 18, wherein
the second processing unit accesses the data storage area of the camera system, and the data storage area of the camera system including the data storage area of the first camera module and the data storage area of the second camera module, and
the data storage area of the first camera module and the data storage area of the second camera module are specified by addresses of a same range of numerical values.

20. The electronic device according to claim 19, wherein the third controller transmits a command including a common address, as a command for the first camera module and a command for the second camera module, to the first controller.
